(19) United States
(12) Patent Application Publication
(10) Pub. No.: US 2025/0142556 A1
(43) Pub. Date: May 1, 2025

(54) COORDINATED FREQUENCY DIVISION MULTIPLE ACCESS

(71) Applicant: Cisco Technology, Inc., San Jose, CA (US)

(72) Inventors: Malcolm M. Smith, Richardson, TX (US); Brian D. Hart, Sunnyvale, CA (US)

(73) Assignee: Cisco Technology, Inc., San Jose, CA (US)

(21) Appl. No.: 18/583,495

(22) Filed: Feb. 21, 2024

Related U.S. Application Data
(63) Continuation-in-part of application No. 18/495,910, filed on Oct. 27, 2023.

(51) Int. Cl. H04W 72/12; H04W 72/541

(52) U.S. Cl. CPC H04W 72/12; H04W 72/541

(57) ABSTRACT

Coordinated Frequency Division Multiple Access (C-FDMA) for the simultaneous transmission of a basic Physical Layer Protocol Data Unit (PPDU) may be provided. C-FDMA may include determining sub-channels of a channel for one or more Access Points (APs). The sub-channels may then be assigned to the one or more APs. Transmit Opportunities (TxOps) may be scheduled for the one or more APs on the sub-channels. It may then be determined that a basic PPDU and an enhanced PPDU will be simultaneously transmitted on adjacent sub-channels. In response to determining the basic PPDU and the enhanced PPDU will be simultaneously transmitted on adjacent sub-channels, one or more Resource Units (RUs) of a sub-channel the enhanced PPDU will be transmitted on may be selected to disable transmission in.

### RELATED APPLICATION

This application is a continuation-in-part (CIP) and claims priority to U.S. patent application Ser. No. 18/495,910 filed Oct. 27, 2023, the disclosure of which is incorporated herein by reference in its entirety.

### TECHNICAL FIELD

The present disclosure relates generally to Coordinated Frequency Division Multiple Access (C-FDMA) and particularly to C-FDMA for enhanced Physical Layer Protocol Data Units (PPDU).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Coordinated Frequency Division Multiple Access (C-FDMA);

FIG. 2 is a first graph of C-FDMA sub-channel allocation;

FIG. 3 is a second graph of C-FDMA sub-channel allocation for the simultaneous transmission of a basic Physical Layer Protocol Data Unit (PPDU) and an enhanced PPDU;

FIG. 4 is a third graph of C-FDMA sub-channel allocation for the simultaneous transmission of a basic PPDU and an enhanced PPDU;

FIG. 5 is a flow chart of a method for C-FDMA; and

FIG. 6 is a block diagram of a computing device.

### DETAILED DESCRIPTION

### Overview

Coordinated Frequency Division Multiple Access (C-FDMA) for the simultaneous transmission of a basic Physical Layer Protocol Data Unit (PPDU) may be provided. C-FDMA may include determining sub-channels of a channel for one or more Access Points (APs). The sub-channels may then be assigned to the one or more APs. Transmit Opportunities (TxOps) may be scheduled for the one or more APs on the sub-channels. It may then be determined that a basic Physical Layer Protocol Data Unit (PPDU) and an enhanced PPDU will be simultaneously transmitted on adjacent sub-channels. In response to determining the basic PPDU and the enhanced PPDU will be simultaneously transmitted on adjacent sub-channels, one or more Resource Units (RUs) of a sub-channel the enhanced PPDU will be transmitted on may be selected to disable transmission in.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

For certain enhanced Physical Layer Protocol Data Units (PPDU), such as an Extremely High Throughput (EHT) PPDU, a High-Efficiency (HE) PPDU, an Ultra High Reliability (UHR) PPDU, and/or the like may be composed of pre-modulated fields and modulated fields. For example, a HE PPDU may have HE pre-modulated fields including a Legacy-Short Training field, a Legacy-Long Training field, a Legacy-Signal field, a Repeated Legacy-Signal field, a HE Signal A field, and a HE Signal B field. The HE PPDU may have modulated fields including a HE Short Training field, a HE Long Training field, a HE Data field, and a Packet Extension field. An enhanced PPDU may be defined by the Institute of Electrical and Electronics Engineers 802.11 standard amendments with one or more letters. For example, the IEEE 802.11be amendment defines the EHT PPDU, the IEEE 802.11ax amendment defines the HE PPDU, the IEEE 802.11bn amendment defines the UHR PPDU, and other IEEE 802.11XX amendments may define other enhanced PPDUs.

The pre-modulated fields of enhanced PPDUs may use four microsecond long Orthogonal Frequency Division Multiplexing (OFDM) symbols with a 3.2 microsecond core and a 0.8 microsecond guard interval (e.g., a cyclical prefix). The modulated fields of enhanced PPDUs may use 3.6 microsecond long symbols, 4 microsecond long symbols, 13.6 microsecond long symbols, 14.4 microsecond long symbols, 16 microsecond long symbols, and/or the like. For some of the symbols of the modulated fields, such as 13.6 microsecond long symbols, 14.4 microsecond long symbols, and 16 microsecond long symbols, the subcarriers are spaced four times as densely as a four microsecond long symbol (i.e., 78.125 kHz spacing instead of 312.5 kHz spacing). A basic PPDU (e.g., as defined by the 802.11a or 802.11g amendments) meanwhile may use four microsecond long symbols throughout the PPDU for each field (i.e., 312.5 kHz subcarrier spacing throughout). In an alternative definition, a basic PPDU includes a PPDU defined by the 802.11a or 802.11g or 802.11n or 802.11ac amendments, which uses four microsecond long symbols for the preamble and 3.6 microsecond or 4 microseconds for the Data field (but still with 312.5 kHz subcarrier spacing throughout).

When a device transmits a basic PPDU simultaneously with an enhanced PPDU, the pre-modulated fields of the enhanced PPDU may be OFDM-symbol-aligned because the pre-modulated fields are four microseconds long. The pre-modulated fields of the enhanced PPDU will therefore be orthogonal with the basic PPDU that uses four microsecond long fields throughout. However, orthogonality may be lost because of the variable length and subcarrier spacing of the modulated fields of the enhanced PPDU or a basic PPDU that uses 3.6 microsecond long symbols for the Data field. For example, OFDM symbols no longer align when the basic PPDU has fields of four microseconds plus four microseconds plus four microseconds, etc. and the enhanced PPDU has fields of 13.6 microseconds plus 13.6 microseconds, etc. Therefore, OFDM symbol boundaries for a field of one of the two PPDUs may overlap with the core of the other PPDU and vice versa. Thus, coordinating the simultaneous transmission of a basic PPDU and an enhanced PPDU an adjacent spectrums, by a single device or multiple devices, may be required.

Frequency coordination in WiFi-8 Multi-Access Point Coordination (MAPC) may define Coordinated Orthogonal Frequency Division Multiple Access (C-OFDMA) for Access Point (AP) coordination to enable simultaneous transmission without interference. Because of the need to maintain the orthogonality of Resource Units (RUs) or tones transmitted by the same or adjacent APs to avoid interference when using C-OFDMA, the transmitters of the adjacent APs may have to be synchronized in both frequency and phase. Ideally, APs may be synchronized to a degree based on the sub-symbol or guard-interval (e.g., every 400 nanoseconds) to ensure the transmissions of APs do not cause interference. For some standard wireless network coordination examples, maintaining the orthogonality of the RUs when using C-OFDMA may be possible to implement because a leader AP may transmit a Trigger-Frame (TF) to all the followers that can be used to establish synchronization. However, other approaches where coordination may be performed over the wired network due to relatively large time-sync errors in that domain may not be able to utilize C-OFDMA without interference. To address the limitations of C-OFDMA, Coordinated Frequency Division Multiple Access (C-FDMA) is described herein. C-FDMA, especially C-FDMA sent by a single AP, also finds utility in communicating with legacy devices using a basic PPDU over a narrow bandwidth while also using most or all of the remaining channel bandwidth to transmit an enhanced PPDU to enhanced PPDU capable devices.

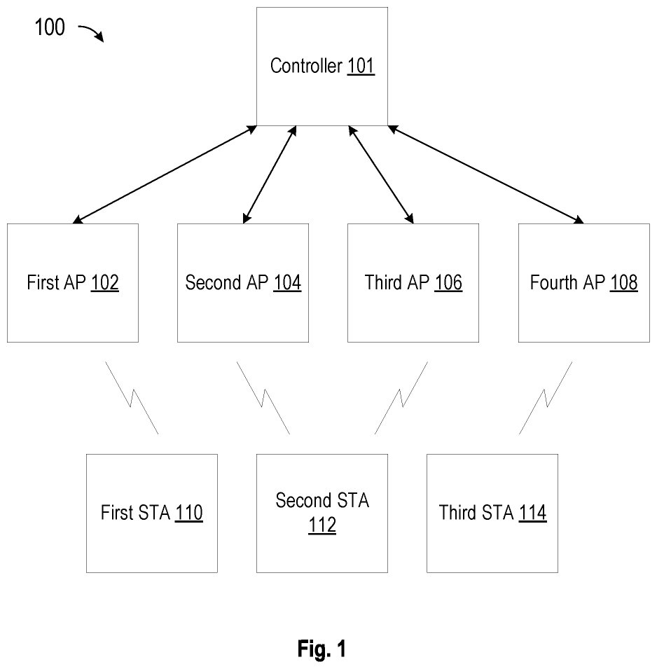

FIG. 1 is a block diagram of an operating environment 100 for (C-FDMA. The operating environment 100 may include a controller 101, a first AP 102, a second AP 104, a third AP 106, a fourth AP 108, a first Station (STA) 110, a second STA 112, and a third STA 114. The controller 101 may be any network controller (e.g., a MAPC controller, a Wireless Local Area Network (WLAN) controller, etc.) operable to control the operations of the network and one or more devices of the network. The controller 101 may control the operation of network devices, such as coordinating APs for MAPC (e.g., implementing C-FDMA). The controller 101 may be co-located with one of the APs.

The first AP 102, the second AP 104, the third AP 106, and the fourth AP 108 may enable devices, such as the first STA 110, the second STA 112, and the third STA 114, to connect to a network. The first STA 110, the second STA 112, and the third STA 114 may be devices that may connect to a network to communicate with devices, transmit and review data, and the like (e.g., a smartphone, a personal computer, a tablet, a laptop, a server, etc.). The operating environment 100 may have a different number of APs and/or STAs in other examples.

A network may utilize C-FDMA by coordinating or otherwise assigning entire non-orthogonal sub-channels (e.g., in the frequency domain) instead of RUs or tones as C-OFDMA requires. For example, the controller 101 and/or some other network device (e.g., the first AP 102, the second AP 104, the third AP 106, or the fourth AP 108 acting as a controlling AP) may determine the coordination and assignment of sub-channels to perform C-FDMA. The sub-channels may have a channel width of twenty Megahertz (MHZ), forty MHZ, and/or the like. The sub-channels may have gaps between them to avoid interference. The controller 101 may determine the sub-channel positions and widths, and therefore the gaps, to ensure sub-channels are separated sufficiently to avoid Adjacent Channel Interference (ACI) that may disrupt the operation of the network.

By coordinating non-orthogonal sub-channels with C-FDMA as opposed to coordinating RUs or sets of orthogonal tones as C-OFDMA requires, the network may have simpler sub-channel granularity and effective frequency division (e.g., no collisions) without the prohibitive symbol-level, time-aligned requirements (e.g., orthogonality guarantee via sub-microsecond time synchronization between APs) of C-OFDMA. C-FDMA may enable the network to use simultaneous Transmit Opportunities (TxOps) across one or more of the first AP 102, the second AP 104, the third AP 106, and the fourth AP 108 (e.g., between the first STA 110, the second STA 112, and/or the third STA 114) without causing appreciable Co-Channel Interference (CCI) on one or more of the first AP 102, the second AP 104, the third AP 106, the fourth AP 108, the first STA 110, the second STA 112, or the third STA 114. Because C-FDMA may alleviate time synchronization requirements to avoid interference, C-FDMA may be used for wired networks.

C-FDMA may be utilized effectively in environments with channels that have a width that enable allocation of distinct sections of the channel (e.g. the bottom 80 MHz and the top 80 MHz in a 320 Mhz channel) to one or more of the first AP 102, the second AP 104, the third AP 106, and the fourth AP 108. For example, the controller 101 may determine sub-channels, including the positions and widths, to create Transmit (Tx) and Receive (Rx) separation. For example, channels described by Wi-Fi 8 would enable C-FDMA.

To determine the which sub-channels the first AP 102, the second AP 104, the third AP 106, and the fourth AP 108 should be assigned, the controller 101 and/or some other network device may estimate the CCI impact on the first AP 102, the second AP 104, the third AP 106, and the fourth AP 108 and on the first STA 110, the second STA 112, and the third STA 114 may have for a sub-channel assignment. The controller 101 may determine the CCI impact on the first AP 102, the second AP 104, the third AP 106, and the fourth AP 108 using AP-to-AP Received Signal Strength Indicator (RSSI) reports (e.g., using the Neighbor Discover Protocol (NDP)) and/or the like. The controller 101 may determine the CCI impact on the first STA 110, the second STA 112, and the third STA 114 using downlink Signal to Interference Ratio (SIR) at the respective STA estimated from beacon reports, using PPDU RSSI reports from neighboring APs, and/or the like. The controller 101 may assign the first AP 102, the second AP 104, the third AP 106, and the fourth AP 108 sub-channels based on the estimated CCI impacts on the first AP 102, the second AP 104, the third AP 106, the fourth AP 108, the first STA 110, the second STA 112, and/or the third STA 114 so interference is minimized or otherwise at acceptable levels. For example, the controller 101 may determine that CCI and/or another interference estimation is below a threshold for a set of sub-channels before assigning the sub-channels to the APs.

In other embodiments, the controller 101 may determine which sub-channels the first AP 102, the second AP 104, the third AP 106, and the fourth AP 108 should use based on spectral efficiency. The controller 101 may evaluate the spectral efficiency realized by different sub-channel assignments using AP-to-STA distances, rogue channel configurations, AP types, and/or the like. For example, the controller 101 may evaluate spectral efficiency using Dynamic Bandwidth Selection (DBS) feedback. The DBS feedback may be STA-initiated, per sub-channel, in real time, and/or the like. The controller 101 may then allocate sub-channels to the first AP 102, the second AP 104, the third AP 106, and the fourth AP 108 for maximal or otherwise acceptable spectral efficiency. For example, the controller 101 may determine the spectral efficiency for a set of sub-channels is above a threshold before assigning the sub-channels to the APs. For the transmission of a basic PPDU and an enhanced PPDU by a single AP, the controller 101 may evaluate the power spectral density of the basic PPDU and the enhanced PPDU to select RUs next to the frequency boundary that will be unenergized. The controller 101 may also ensure that the MCS selection can tolerate the residual interference still present.

Once the first AP 102, the second AP 104, the third AP 106, and the fourth AP 108 are assigned sub-channels, the first AP 102, the second AP 104, the third AP 106, and the fourth AP 108 may share a time schedule (e.g., from a Coordinated Time Division Multiple Access (C-TDMA) scheduler, from Stream Classification Service (SCS) flows, etc.) and may not require any other coordination. The first AP 102, the second AP 104, the third AP 106, and the fourth AP 108 may then determine which STA (e.g., the first STA 110, the second STA 112, and/or the third STA 114) to serve in subsequent TxOps using the assigned sub-channels via C-FDMA.

C-FDMA may be used to prevent interference between a basic PPDU and an enhanced PPDU when one or more of the first AP 102, the second AP 104, the third AP 106, and/or the fourth AP 108 will simultaneously transmit the basic PPDU and the enhanced PPDU on adjacent spectrums. For example, the controller 101 may specify a guard band or sub-channel between the basic PPDU and the enhanced PPDU using C-FDMA to prevent interference. The enhanced PPDU may support OFDMA within the enhanced PPDU's band during the modulated fields, so the controller 101 can cause the first AP 102, the second AP 104, the third AP 106, and/or the fourth AP 108 to not transmit energy at specific RUs during the enhanced PPDU transmission. Preventing the transmission of energy at the specific RUs may lower or eliminate the adjacent channel interference on the used subcarriers. Additionally, the controller 101 may cause the first AP 102, the second AP 104, the third AP 106, and/or the fourth AP 108 to use a Modulation and Coding Scheme (MCS) lower than a noise-limited MCS selection on RUs near the RUs where energy transmission is prevented to increase adjacent sub-channel interference immunity on used subcarriers that are still affected by adjacent channel interference. A transmission on an RU may have lower power, thereby resulting in less interference, and the transmission might use a lower MCS thereby maintaining the reliability of the transmission.

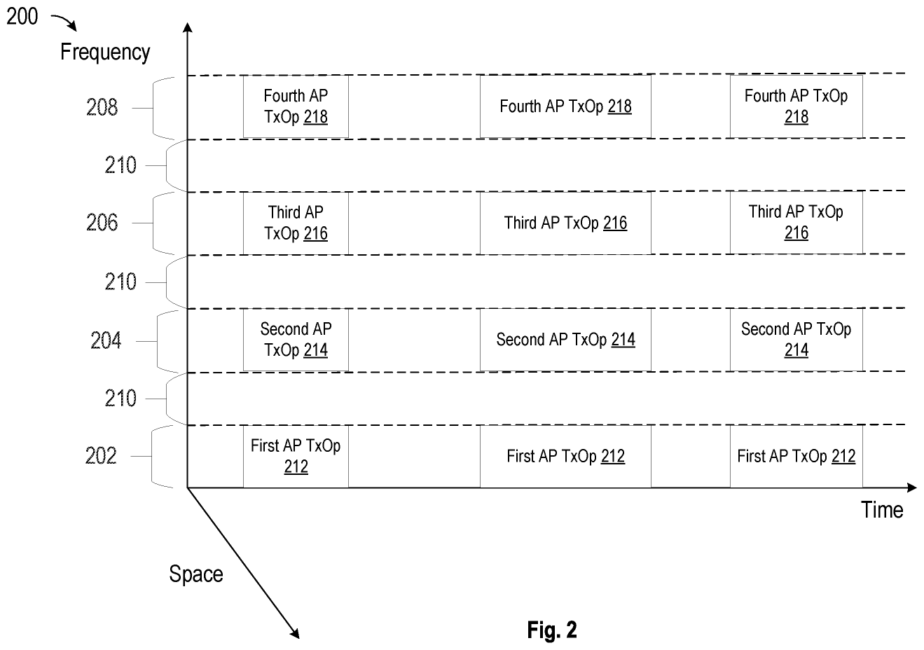

FIG. 2 is a first graph 200 of C-FDMA sub-channel allocation. The first graph 200 may include a first AP sub-channel 202, a second AP sub-channel 204, a third AP sub-channel 206, a fourth AP sub-channel 208 and gaps 210. The controller 101 may determine the positions and widths of the first AP sub-channel 202, the second AP sub-channel 204, the third AP sub-channel 206, the fourth AP sub-channel 208 and the gaps 210 to avoid interference as described above. The first AP sub-channel 202, the second AP sub-channel 204, the third AP sub-channel 206, and the fourth AP sub-channel 208 may have the same width in the first graph 200, but the controller 101 may determine different widths in other examples, for example based on the expected operations of the associated APs. The gaps 210 may have the same width in the first graph 200, but the controller 101 may determine different gaps 210 between the sub-channels in additional examples.

The gaps 210 may be sized and used during the simultaneous transmission of a basic PPDU and an enhanced PPDU to prevent interference. For example, the gap 210 may be determined based on selected RUs where the transmission of energy is prevented to lower or eliminate the adjacent channel interference on the used subcarriers. Additional RUs near the selected RUs may also have an assigned lower MCS to further increase a tolerance to the interference.

The first AP 102 may have one or more first AP TxOps 212 in the first AP sub-channel 202. The first AP 102 may communicate with (e.g., Tx and/or RX) the first STA 110, the second STA 112, and/or the third STA 114 during a first AP TxOp 212. Similarly, the second AP 104 may have one or more second AP TxOps 214 in the second AP sub-channel 204, the third AP 106 may have one or more third AP TxOps 216 in the third AP sub-channel 206, and the fourth AP 108 may have one or more fourth AP TxOps 218 in the fourth AP sub-channel 208. The controller 101 may determine the times the first AP TxOps 212, the second AP TxOps 214, the third AP TxOps 216, and the fourth AP TxOps 218 occur. The controller 101 may align the TxOps to occur at the same time in some examples or may independently schedule the TxOps.

In some examples, the controller 101 may determine Tx sub-channels and Rx sub-channels for each AP. Thus, the first AP 102, the second AP 104, the third AP 106, and the fourth AP 108 may each have two sub-channels, one for Tx and one for Rx, instead of the single sub-channel as shown in the first graph 200. The controller 101 may position the Tx and Rx channels for sufficient frequency separation to avoid interference.

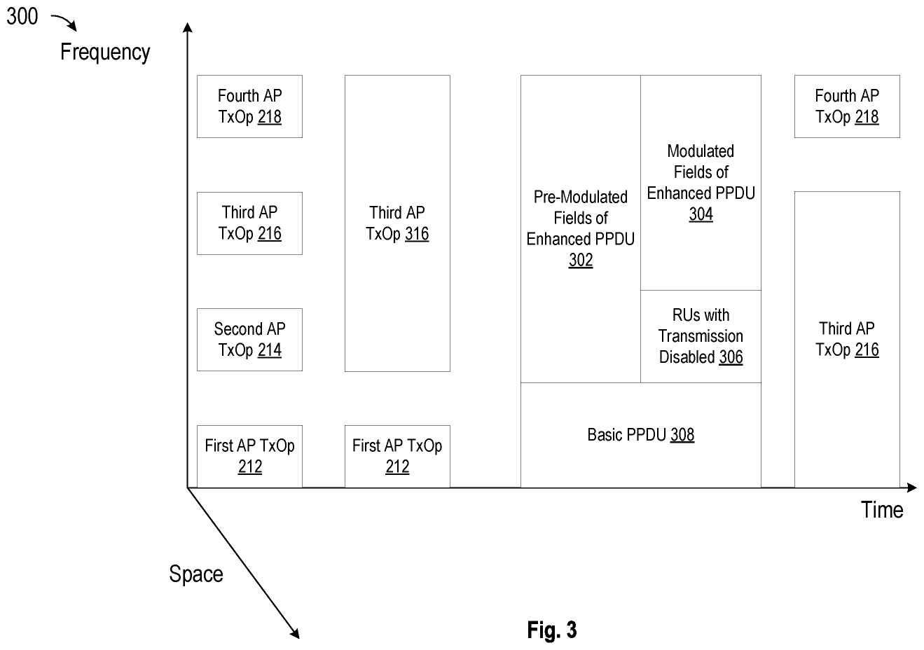

FIG. 3 is a second graph 300 of C-FDMA sub-channel allocation for the simultaneous transmission of a basic PPDU and an enhanced PPDU. The second graph 300 includes different combinations of TxOps, such as the first AP TxOp 212, the second AP TxOp 214, the third AP TxOp 216, and the fourth AP TxOp 218 scheduled simultaneously such as shown in the first graph 200, the first AP TxOp 212 and the third AP TxOp 316 scheduled simultaneously, and the third AP TxOp 316 and the fourth AP TxOp 218 scheduled simultaneously. The second graph 300 additionally includes pre-modulated fields of an enhanced PPDU 302, modulated fields of the enhanced PPDU 304, RUs with Transmission Disabled 306, and a basic PPDU 308. One or more of the first AP 102, the second AP 104, the third AP 106, and the fourth AP 108 may transmit the pre-modulated fields of an enhanced PPDU 302, the modulated fields of the enhanced PPDU 304, and the basic PPDU 308.

The controller 101 may identify that the enhanced PPDU (i.e., the pre-modulated fields of an enhanced PPDU 302 and the modulated fields of the enhanced PPDU 304) and the basic PPDU 308 are scheduled to be transmitted simultaneously. In response to identifying the simultaneous transmission, the controller 101 may select the RUs with transmission disabled 306 to lower or eliminate interference between the enhanced PPDU and the basic PPDU 308. The controller 101 may additionally adjust the MCS and/or transmission power of RUs to further lower interference or increase resiliency to interference.

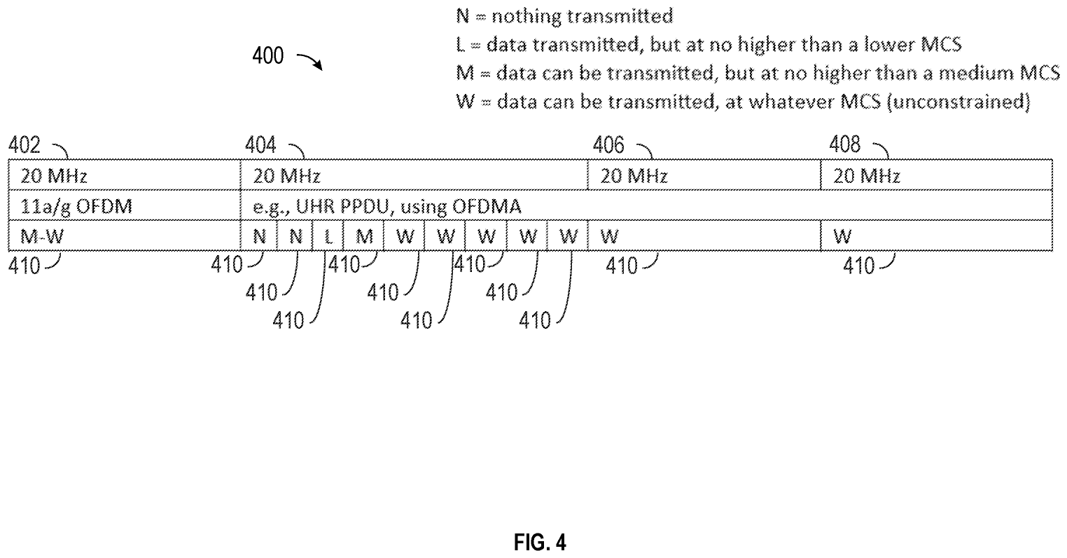

FIG. 4 is a third graph 400 of C-FDMA sub-channel allocation for the simultaneous transmission of a basic PPDU and an enhanced PPDU. The third graph 400 includes a first sub-channel 402, a second sub-channel 404, a third sub-channel 406, and a fourth sub-channel 408. The first sub-channel 402, the second sub-channel 404, the third sub-channel 406, and the fourth sub-channel 408 may comprise RUs 410. The controller 101 may control whether transmission is enabled for each RU 410 and the MCS of each RU 410. Assigning a lower MCS may result in a transmission more resilient to interference. As well or instead, the power of an RU might be reduced, thereby reducing the interference the RU generates, along with a lower MCS to maintain reliability.

A basic PPDU may be transmitted via the first sub-channel 402, and an enhanced PPDU may be transmitted via the second sub-channel 404, the third sub-channel 406, and the fourth sub-channel 408. Therefore, the basic PPDU waveform is 20 MHz and the enhanced PPDU waveform is 60 MHz. To prevent interference between the basic PPDU and the enhanced PPDU, the controller may select or otherwise determine RUs 410 where transmitting is disabled and/or where the MCS will be lower than what the noise-limited choice of MCS would be. The lowest 20 MHz of 60 MHz enhanced PPDU (i.e., the second sub-channel 404) may use smaller RUs or Multiple RUs (MRUs). Nine 26-tone RUs are illustrated in this example, but any allowed combination is possible (e.g., 26-tone RUs, 52-tone RUs, 106-tone RUs, 242 tone RUs, 26-tone and 106-tone RUs, 52-tone and 106-tone RUs, etc.). Near the boundary of the first sub-channel 402 and the second sub-channel 404, the RUs may be unused. For example, the controller 101 may select the first two RUs of the second sub-channel 404 from the boundary of the first sub-channel 402 to disable transmission on or otherwise be unused.

Additionally, the controller 101 can select other RUs 410 for enabling transmission at a lower MCS than what the noise-limited choice of MCS would be. For example, the controller 101 may select the third RU 410 of the second sub-channel 404 from the boundary of the first sub-channel 402 to operate at a lower MCS than a noise-limited choice of MCS. The controller 101 may also select the fourth RU 410 of the second sub-channel 404 from the boundary of the first sub-channel 402 to operate at a lower MCS than a MCS that would be selected in an absence of interference from the basic PPDU but higher than the MCS of the third RU 410. In some embodiments, the max allowed MCS for each RU 410 is calculated (e.g., by an algorithm) or mandated by a specification outlining operating requirements for each RU 410 position based on its separation from the basic PPDU. In some examples, the basic PPDU is in an interior sub-channel, so the guard band of RUs 410 that have no transmission and/or lower-MCS may be applied to each side of the basic PPDU.

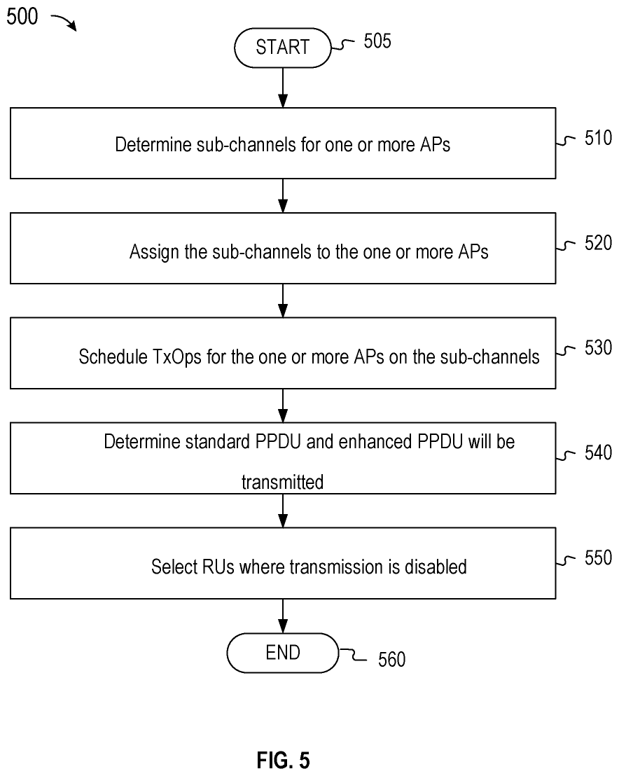

FIG. 5 is a block diagram of a method 500 for C-FDMA. The method 500 may begin as starting block 505 and proceed to operation 510. In operation 510, sub-channels of a channel may be determined for one or more APs. For example, the controller 101 may determine sub-channels for the first AP 102, the second AP 104, the third AP 106, and/or the fourth AP 108. The controller 101 may estimate interference (e.g., CCI) and/or spectral efficiency to determine the positions and widths of the sub-channels. The controller 101 may also determine a Tx sub-channel and a Rx sub-channel for each AP in some examples.

In operation 520, the sub-channels may be assigned to the one or more APs. For example, the controller 101 may inform the first AP 102, the second AP 104, the third AP 106, and the fourth AP 108 the sub-channel(s) each AP is assigned.

In operation 530, TxOps for the one or more APs may be scheduled on the sub-channels. For example, the controller 101 may schedule TxOps at different times, including simultaneously, for the APs. For example, the controller 101 may schedule the first AP TxOps 212, the second AP TxOps 214, the third AP TxOps 216, and the fourth AP TxOps 218.

In operation 540, it is determined that a basic PPDU and an enhanced PPDU will be simultaneously transmitted on adjacent sub-channels. For example, the controller 101 determines that a basic PPDU and an enhanced PPDU were scheduled to be simultaneously transmitted during operation 530.

In operation 550, RUs where transmissions are disabled are selected. For example, the controller 101 determines one or more RUs on the sub-channel where the enhanced PPDU will be transmitted. The controller 101 may select the one or more RUs to lower or eliminate the interference between the basic PPDU and the enhanced PPDU. The controller 101 may additionally select one or more RUs to have a lower MCS so they are more resilient to interference and/or reduce the transmission powers of one or more RUs to decrease the interference the one or more RUs generate. The method 500 may conclude at ending block 560.

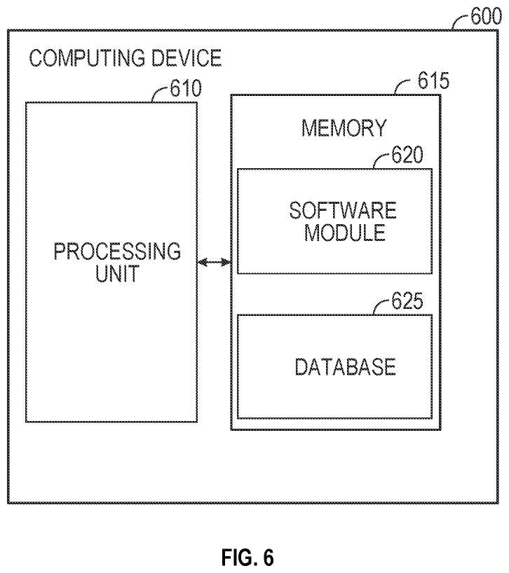

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for C-FDMA with respect to FIG. 1, FIG. 2, FIG. 3, FIG. 4, and FIG. 5. Computing device 600, for example, may provide an operating environment for the controller 101, the first AP 102, the second AP 104, the third AP 106, the fourth AP 108, the first STA 110, the second STA 112, the third STA 114, and the like. The controller 101, the first AP 102, the second AP 104, the third AP 106, the fourth AP 108, the first STA 110, the second STA 112, the third STA 114, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining sub-channels of a channel for one or more Access Points (APs);
assigning the sub-channels to the one or more APs;
scheduling Transmit Opportunities (TxOps) for the one or more APs on the sub-channels;
determining a basic Physical Layer Protocol Data Unit (PPDU) and an enhanced PPDU will be simultaneously transmitted on adjacent sub-channels; and
in response to determining the basic PPDU and the enhanced PPDU will be simultaneously transmitted on adjacent sub-channels:
for one or more sub-channels of the enhanced PPDU, selecting one or more Resource Units (RUs) to disable transmission on.

2. The method of claim 1, wherein the sub-channels have any one of a width of: (i) twenty Megahertz (MHZ), (ii) forty MHz, or (iii) a combination of (i) and (ii).

3. The method of claim 1, wherein determining the sub-channels comprises determining positions of the sub-channels to create gaps between the sub-channels.

4. The method of claim 1, further comprising:
for the one or more sub-channels of the enhanced PPDU, selecting one or more additional RUs to assign a new Modulation Coding Scheme (MCS) lower than a first MCS, wherein the first MCS would be selected in an absence of interference from the basic PPDU.

5. The method of claim 4, wherein the new MCS is calculated based on a distance between the one or more additional RUs and a sub-channel the basic PPDU will be transmitted on.

6. The method of claim 4, further comprising:
for the one or more sub-channels of the enhanced PPDU, selecting one or more further RUs to assign a second MCS lower than the first MCS and higher than the new MCS.

7. The method of claim 6, wherein the second MCS is calculated based on a distance between the one or more additional RUs and a sub-channel the basic PPDU will be transmitted on.

8. A system comprising:
a memory storage; and
a processing unit coupled to the memory storage, wherein the processing unit is operative to:
determine sub-channels of a channel for one or more Access Points (APs);
assign the sub-channels to the one or more APs;
schedule Transmit Opportunities (TxOps) for the one or more APs on the sub-channels;
determine a basic Physical Layer Protocol Data Unit (PPDU) and an enhanced PPDU will be simultaneously transmitted on adjacent sub-channels; and
in response to determining the basic PPDU and the enhanced PPDU will be simultaneously transmitted on adjacent sub-channels:
for one or more sub-channels of the enhanced PPDU, select one or more Resource Units (RUs) to disable transmission on.

9. The system of claim 8, wherein the sub-channels have any one of a width of: (i) twenty Megahertz (MHZ), (ii) forty MHz, or (iii) a combination of (i) and (ii).

10. The system of claim 8, wherein to determine the sub-channels comprises to:
estimate Co-Channel Interference (CCI); and
determine the CCI is below a threshold.

11. The system of claim 8, wherein to determine the sub-channels comprises to determine positions of the sub-channels to create gaps between the sub-channels.

12. The system of claim 8, wherein the processing unit is further operative to:
for the one or more sub-channels of the enhanced PPDU, select one or more additional RUs to assign a new Modulation Coding Scheme (MCS) lower than a first MCS, wherein the first MCS would be selected in an absence of interference from the basic PPDU.

13. The system of claim 12, wherein the new MCS is calculated based on a distance between the one or more additional RUs and a sub-channel the basic PPDU will be transmitted on.

14. The system of claim 12, wherein the processing unit is further operative to:
for the one or more sub-channels of the enhanced PPDU, select one or more further RUs to assign a second MCS lower than the first MCS and higher than the new MCS.

15. A non-transitory computer-readable medium that stores a set of instructions which when executed perform a method executed by the set of instructions comprising:
determining sub-channels of a channel for one or more Access Points (APs);
assigning the sub-channels to the one or more APs;
scheduling Transmit Opportunities (TxOps) for the one or more APs on the sub-channels;
determining a basic Physical Layer Protocol Data Unit (PPDU) and an enhanced PPDU will be simultaneously transmitted on adjacent sub-channels; and
in response to determining the basic PPDU and the enhanced PPDU will be simultaneously transmitted on adjacent sub-channels:
for one or more sub-channels of the enhanced PPDU, selecting one or more Resource Units (RUs) to disable transmission on.

16. The non-transitory computer-readable medium of claim 15, wherein the sub-channels have any one of a width of: (i) twenty Megahertz (MHZ), (ii) forty MHz, or (iii) a combination of (i) and (ii).

17. The non-transitory computer-readable medium of claim 15, wherein determining the sub-channels comprises determining positions of the sub-channels to create gaps between the sub-channels.

18. The non-transitory computer-readable medium of claim 15, the method executed by the set of instructions further comprising:
for the one or more sub-channels of the enhanced PPDU, selecting one or more additional RUs to assign a new Modulation Coding Scheme (MCS) lower than a first MCS, wherein the first MCS would be selected in an absence of interference from the basic PPDU.

19. The non-transitory computer-readable medium of claim 18, wherein the new MCS is calculated based on a distance between the one or more additional RUs and a sub-channel the basic PPDU will be transmitted on.

20. The non-transitory computer-readable medium of claim 18, the method executed by the set of instructions further comprising:
for the one or more sub-channels of the enhanced PPDU, selecting one or more further RUs to assign a second MCS lower than the first MCS and higher than the new MCS.
